(19) United States
(12) Patent Application Publication
(10) Pub. No.: US 2013/0091064 A1
(43) Pub. Date: Apr. 11, 2013

(54) PRICING OPEN-LIST WARRANTIES

(71) Applicants: Julie Ward Drew, Redwood City, CA (US); Filippo Balestrieri, Mountain View, CA (US); Ruxian Wang, New York, NY (US)

(72) Inventors: Julie Ward Drew, Redwood City, CA (US); Filippo Balestrieri, Mountain View, CA (US); Ruxian Wang, New York, NY (US)

(21) Appl. No.: 13/267,425

(22) Filed: Oct. 6, 2011

(51) Int. Cl. G06Q 50/10

(52) U.S. Cl. 705/302

(57) ABSTRACT

Systems, methods, and computer-readable and executable instructions are provided for pricing open-list warranties. Pricing open-list warranties can include determining an expected product support cost of a provider of an open-list warranty to a customer over a time period, determining an expected product repair cost of the customer over the time period, and pricing the open-list warranty for the time period based on the expected product support cost and the expected product repair cost.

### BACKGROUND

Warranties offer an opportunity of a connection between a provider (e.g., a product manufacturer and/or seller) and the customer beyond the moment of purchase. Open-list warranties offer customers the opportunity to purchase a single service contract and/or multiple service contracts associated with a number of products without specifying at the time of purchase which product(s) will be supported under the warranty. An example of an open-list warranty is a service contract that the customer can tie to a hardware serial number at the time service is needed.

Open-list warranties enhance flexibility from the customer's perspective and can create incentives to purchase more products from the seller. However, compared with tied-at-purchase warranties, open-list warranties carry increased expected product support costs for providers, and make the product support costs more difficult to estimate.

### BRIEF DESCRIPTION OF THE DRAWINGS

FIG. 1 is a flow chart illustrating an example of a method for pricing an open-list warranty in accordance with one or more examples of the present disclosure.

FIG. 2 is a flow chart illustrating an example of a method for pricing an open-list warranty in accordance with one or more examples of the present disclosure.

FIG. 3 illustrates a block diagram of an example of a computer-readable medium in communication with processing resources for pricing an open-list warranty in accordance with one or more examples of the present disclosure.

### DETAILED DESCRIPTION

Examples of the present disclosure include methods, systems, and computer-readable and executable instructions and/or logic. An example method for pricing an open-list warranty can include determining an expected product support cost of a provider of an open-list warranty to a customer over a time period, determining an expected product repair cost of the customer over the time period, and pricing the open-list warranty for the time period based on the expected product support cost and the expected product repair cost.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

A warranty can be an assurance that some product or service will be provided or will meet certain specifications. Warranties can be used to assist in the management of customer relationships or as a mechanism to retain customers. Warranties can take several forms. One type of warranty is an open-list warranty. An open-list warranty can differ from a tied-at-purchase (e.g., traditional) warranty because, for example, a customer can elect to tie serial numbers of purchased products to support services when the customer needs the support services (e.g., a purchased product fails), rather than at the time of purchase. Open-list warranties can make warranty contracts more flexible from the customer's perspective. For example, a computer hardware vendor may also be a provider of warranties for the hardware the vendor sells. Providing open-list warranties can create incentives for customers to buy more hardware from the vendor because, for example, customers may determine that open-list warranties are more economically convenient than tied-at-purchase warranties (e.g., warranties tied to specific serial numbers of hardware at the time of purchase).

Open-list warranties can increase expected product support costs for providers as customers purchase more products under one or more open-list warranties. Thus, a trade-off can exist for a provider of open-list warranties: as sales increase, expected costs can also increase. Open-list warranties can support a wide variety of products including, but not limited to: computing devices, printers, fax machines, and/or display devices.

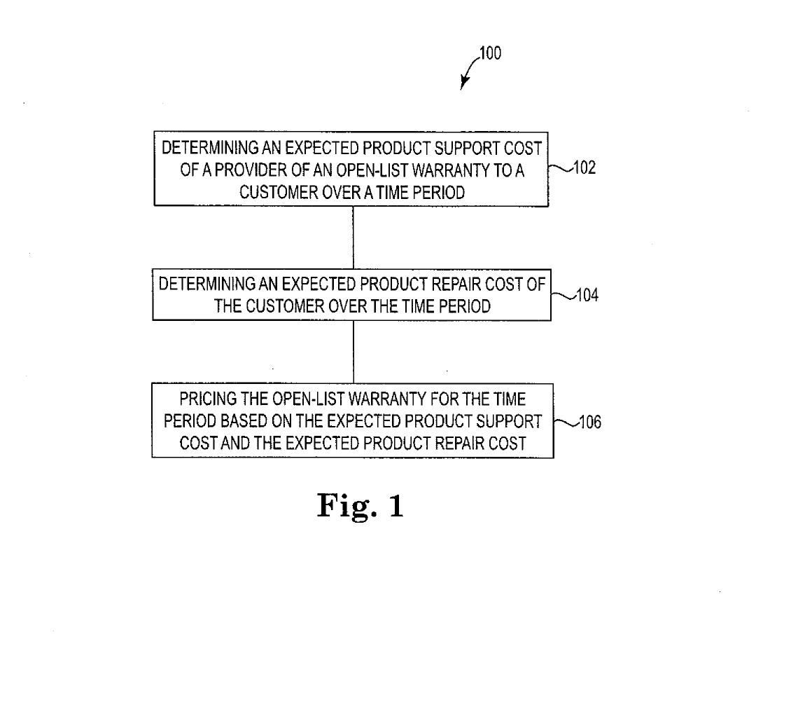

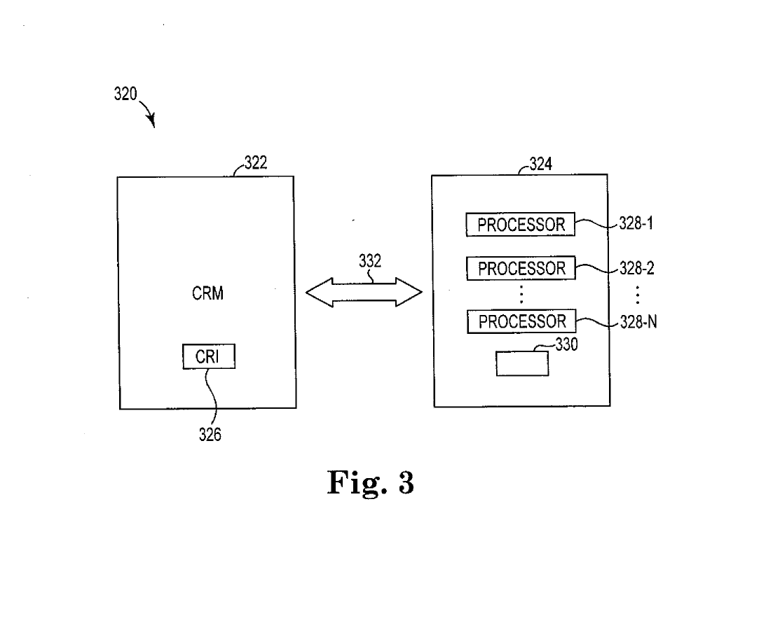

FIG. 1 is a flow chart illustrating an example method 100 for pricing an open-list warranty in accordance with one or more examples of the present disclosure. Method 100 can be carried out, for example, by computing system 320 as discussed below in connection with FIG. 3.

At block 102, method 100 includes determining an expected product support cost of a provider of an open-list warranty to a customer over a time period. An expected product support cost can include, for example, expected costs associated with replacement and/or repair services. Additionally, expected product support costs can include other costs, for example, servicing, upgrading, shipping and/or short-term replacement (e.g., loaning). Expected product support costs can also include wages and/or transportation costs paid to service representatives of the provider. Provider, as used herein, can refer to a provider of an open-list warranty and can, for example, include manufacturers, sellers, wholesalers, retailers, etc. A provider can include individuals, companies, corporations, and/or partnerships, among other legal entities. A customer can include a purchaser of a number of products supported under a warranty and/or a purchaser of the warranty itself. A customer can include a purchaser, the purchaser's family, heirs and/or assigns, and other individuals and/or legal entities able to enter into a contract that includes a warranty.

Time period, as used herein, can refer to the life of the warranty (e.g., a number of days and/or years) or can refer to a different time period. Examples of the present disclosure can allow variability of the time period used in method 100 because pricing can depend on, for example, the length of the time period, among other things.

Determining an expected product support cost of a provider of an open-list warranty can include determining a number of products owned by the customer and a number of the products (e.g., still unnamed products) owned by the customer that the customer can use the open-list warranty to support. In an example, a customer owns N products and the customer owns an open-list warranty that can be used to support up to n of those products (e.g., a maximum of n of the N products). Determining an expected product support cost can include discretizing (e.g., fragmenting) the time period into smaller time periods (e.g., portions of the time period) sufficiently small such that a product owned by the customer can be expected to fail at most once during one of the portions (e.g., fragments) of the time period. In an example, S(N,n,t) can represent the provider's expected product support cost (S) over t portions of the time period to support a customer that owns N products when the customer has an open-list warranty that can be used to support up to n eligible products (e.g., named and/or unnamed products).

The provider's expected product support cost can, for example, be divided in two components: fixed costs and variable costs. P=F+S. The fixed component can include costs such as, for example, wages and infrastructure costs. The variable component depends on the cost to repair a single product and/or the probability of a single product failing within a portion of the time period, among other factors. In an example, the provider's repair cost can be denoted by a random variable X with an expected value EX. Continuing in the example, the probability of i failures in a portion of the time period out of N products, where the probability of any given product failing in a portion of the time period is p, can be expressed as a binomial probability distribution, denoted as f (i,N,p). For example,

$$f ( i , N , p ) = \frac{N !}{i ! ( N - i ) !} {{p}^{i} ( 1 - p )}^{N - i} ,$$

where i represents factorial operation and n!=n·(n−1) . . . 2·1. In an example, the provider may charge the customer a fixed co-payment q. It can be assumed that the value of q is lower than the minimum price charged for out-of-warranty repairs. In another example, the copayment can be proportional to the expected cost, so that the provider covers a fraction (1−q)EX.) In this example, q=0 corresponds to the particular case of full coverage by the provider. Additionally, larger values of q can correspond to a smaller of degree (e.g., level and/or amount) of coverage associated with the warranty (e.g., degrees of partial coverage and/or full coverage). The variable component of the provider's expected product support cost over the time period, as previously discussed, S(N,n,t), can be determined recursively by conditioning on the number of products (i) expected to fail in the next portion of the time period:

$$S ( N , n , t ) = \{ \begin{matrix}0 & if n = 0 \\ \begin{matrix}{\sum }_{i = 0}^{n} f ( i ; N , p ) ( \begin{matrix}i ( 1 + p ( t - 1 ) ) EX + \\ S ( N - i , n - i , t - 1 )\end{matrix} ) + \\ {\sum }_{i = n + 1}^{N} f ( i ; N , p ) ( nEX + npEX ( t - 1 ) )\end{matrix} & if 0 < n < N \\ NtpEX & if n \geq N .\end{matrix}$$

At block 104, method 100 includes determining an expected product repair cost of the customer over the time period. A customer product repair cost can include, for example, costs incurred by the customer for failures of products that are not supported by the customer's open-list warranty (e.g., out-of-warranty product repair costs). In an example, C(N,n,t) can represent the expected customer product repair cost over the time period (e.g., the time period fragmented into t portions of the time period) for N products that the customer owns, n of which can be supported by the customer's open-list warranty.

The expected customer product repair cost can, for example, depend on the cost to repair a single product and/or the probability of a single product failing within a portion of the time period, among other factors. In an example, the customer's out-of-warranty repair cost for a failure that may occur can be denoted by a random variable R with an expected value ER. Continuing in the example, the probability of i failures in a portion of the time period out of N products, where the probability of any given product failing in a portion of the time period is p, can be denoted as f (i,N,p). Additionally, a co-payment can be charged to the customer at a time one or more of the customer's products fail (e.g., due to an accident). The co-payment charged to the customer can be denoted as q. The expected customer product repair cost over the time period, as previously discussed, C(N,n,t), can be determined recursively by conditioning on the number of products (i) expected to fail in the next portion of the time period:

$$C ( N , n , t ) = \{ \begin{matrix}NtpER & if n = 0 \\ \begin{matrix}{\sum }_{i = 0}^{n} f ( i ; N , p ) ( \begin{matrix}iq + iqp ( t - 1 ) + \\ C ( N - i , n - i , t - 1 )\end{matrix} ) ++ \\ {\sum }_{i = n + 1}^{N} f ( i ; N , p ) ( \begin{matrix}nq + nqp ( t - 1 ) + \\ ( i - n ) ER + ( N - n ) pER ( t - 1 )\end{matrix} )\end{matrix} & if 0 < n < N \\ Ntpq & if n \geq N .\end{matrix}$$

Although not shown in FIG. 1, method 100 can include determining a variance of the expected customer product repair cost. A variance of the customer product repair cost can be used, for example, to price an open-list warranty for a number of customers that are not risk-neutral. For example, the expected customer product repair cost, as previously discussed in connection with block 102, can assume a neutral customer with respect to risk attitude. As discussed below, examples of the present disclosure do not assume only risk-neutral customers; rather, a customer can have a risk attitude falling in a continuum between risk-seeking and risk-averse.

In an example, Z(N,n,t) can represent the variance (Z) of the customer product repair cost over a time period (e.g., a time period fragmented into t portions of the time period) for N products that the customer owns, n of which can be supported by the customer's open-list warranty. In an example, D(N,n,t) can represent the expectation of the square of customer product repair cost over a time period (e.g., a time period fragmented into t portions of the time period) for N products that the customer owns, n of which can be supported by the customer's open-list warranty. The variance (Z) of the customer product repair cost can be expressed as:

Z(N,n,t)=D(N,n,t)−C²(N,n,t).

The expectation (D) of the square of the customer product repair cost can be determined recursively by conditioning on the number of products expected to fail in the next portion of the time period. Method 100 can include an assumption that the customer product repair cost is deterministic and constant (R=ER=c). Method 100 can include an assumption that the customer product repair cost is random. Under an assumption that the customer product repair cost is deterministic and constant,

$$D ( N , n , t ) = \{ \begin{matrix}{( Ntpc )}^{2} + Ntp ( 1 - p ) {c}^{2} & if n = 0 \\ \begin{matrix}{\sum }_{i = 0}^{n} f ( i ; N , p ) \{ \begin{matrix}E [ {( iq + W ( i , t - 1 ) )}^{2} ] + \\ D ( N - i , n - i , t - 1 ) + \\ 2 ( iq + EW ( i , t - 1 ) ) C ( \begin{matrix}N - i , \\ n - i , t - 1\end{matrix} )\end{matrix} \} ++ \\ {\sum }_{i = n + 1}^{N} f ( i ; N , p ) E [ {( \begin{matrix}nq + ( i - n ) c + \\ W ( n , t - 1 ) + Q ( N - n , t - 1 )\end{matrix} )}^{2} ]\end{matrix} & if 0 < n < N \\ {( Ntpq )}^{2} + Ntp ( 1 - p ) {q}^{2} & if n \geq N\end{matrix}$$

where Q(N−n,t−1) represents a random variable representing the customer product repair cost over t−1 portions of the time period for the number of products not supported by the open-list warranty (N−n), and

E[Q(N−n,t−1)]=(N−n)(t−1)pc,

E[(Q(N−n,t−1))²]=((N−n)(t−1)pc)²+(N−n)(t−1)p(1−p)c².

Also, W(n,t−1) can be a random variable representing the customer copayment cost over t−1 portions of the time period for the number of products n supported by the open list warranty and

E[W(n,t−1)]=n(t−1)pq,

E[(W(n,t−1))²]=(n(t−1)pq)²+n(t−1)p(1−p)q².

At block 106, method 100 includes pricing the open-list warranty for the time period based on the expected product support cost and the expected product repair cost. Pricing the open-list warranty can include comparing an expected customer perspective on the open-list warranty with an expected customer perspective on a tied-at-purchase warranty, as discussed below. An expected customer perspective can, for example, indicate a quantity of products the customer is expected to purchase.

Pricing the open-list warranty can include making a determination that customers differ in two dimensions: first, with respect to a marginal utility of each incremental unit of a particular product that a customer owns; second, with respect to a risk attitude of a customer. In an example, an index w can represent a customer type, and α(w) can represent a fraction of a population of customers that is type w. For a customer of type w, a net expected utility that customer derives from owning i units of a product over the next t portions of the time period can be expressed as:

U_{w}(i)=u_{w}(i,h)−min {min_{j≦i}{jpₜᵣ+V_{w}^{tr}(i,j)}, min_{k≦i}{kpₒ+V_{w}^{o}(i,k)}},

where u_{w}(i) can represent a utility a customer of type w derives from i units of the product; h can represent the unit price of the product; pₜᵣ can represent a unit price of a tied-at-purchase warranty; pₒ can represent a unit price of the open-list warranty that can support up to nₒ products; V_{w}^{tr}(i,j) can represent an expected disutility of a product repair cost to the customer of type w from owning j tied-at-purchase warranties for the i products; and V_{w}^{o}(i,k) can represent an expected disutility of a product repair cost to the customer of type w from owning k open-list warranties (each of which can support up to nₒ products) for the i products.

The expected disutilities V_{w}^{tr}(i,j) and V_{w}^{o}(i,k) can be quantities that represent a degree to which the customer dislikes the product repair costs associated with owning j tied-at-purchase warranties and owning k open-list warranties for the i products, respectively. The form of the disutility function can depend on the risk attitude of the customer. For example, if customer type w is risk-neutral, the disutility of repair cost can equal the expected repair cost. If the customer is risk averse, the disutility can be a function of both expected repair cost and variance of repair cost.

The equation for net utility, as previously discussed, can reflect an assumption that the customer can make three expected decisions in any order: (1) what quantity of products (i) to purchase; (2) whether to purchase the tied-at-purchase warranty at price pₜ or the open-list warranty at unit price pₒ; and/or (3) what quantity of the tied-at-purchase or open-list warranties to purchase.

Although not shown in FIG. 1, method 100 can include expecting that customers can have different risk attitudes. In an example, the functions V_{w}^{tr}(i,j) and/or V_{w}^{o}(i,k) can account for a risk attitude around an uncertain component of customer product repair cost because, for example, the prices and product utility for the tied-at-purchase warranty and/or open-list warranty can be exogenous and deterministic. For a risk-neutral customer owning one or more tied-at-purchase warranties, the expected disutility of the customer product repair cost can be equal to the expected customer product repair cost: V_{w}^{tr}(i, j)=(i−j)ptER. If the risk-neutral customer owns one or more open-list warranties, the disutility of having k open-list warranties providing support for i products can be equal to the expected customer product repair cost determined recursively, as previously discussed in connection with block 104: V_{w}^{tr}(i,j)=C(i,knₒ,t).

For risk-averse customers, the expected disutility of the customer product repair cost can depend on the variance of the customer product repair cost, as previously discussed. Examples of the present disclosure do not limit customers to risk-neutral and/or risk-averse. In an example, pricing the open-list warranty can include placing a higher importance on the variance for customers that deviate from risk-neutral.

From the three expected decisions that can be made by the customer, as previously discussed, method 100 can include determining three additional values. The three additional values can represent decisions made by the customer that, for example, increase a customer's utility from the product(s), decrease a customer's disutility from owning a number of tied-at purchase warranties, and decrease a customer's disutility from owning a number of open-list warranties. In an example, the three additional values include a number of products for which the utility of the customer can not further increase (e.g., a maximum of the customer's expected utility):

$${i}^{*} ( w ) = {argmax}_{i} {U}_{w} ( i ) ;$$

a number of tied-at-purchase warranties from which the disutility of the customer can not further decrease (e.g., a minimum of the customer's expected disutility repair cost):

$${j}^{*} ( w ) = {argmin}_{j \leq {i}^{*} ( w )} \{ {jp}_{tr} + {V}_{w}^{tr} ( {i}^{*} ( w ) , j ) \} ;$$

and a number of open-list warranties from which the disutility of the customer can not further decrease (e.g., a minimum of the customer's expected disutility of repair):

$${k}^{*} ( w ) = {argmin}_{k \leq {i}^{*} ( w )} \{ {kp}_{o} + {V}_{w}^{o} ( {i}^{*} ( w ) , k ) \} .$$

Pricing the open-list warranties can include determining a number of products representing a minimum number of products at which the customer is indifferent between a tied-at-purchase warranty and an open-list warranty. In an example, a minimum number of products (î(w)) at which the customer is indifferent between a tied-at-purchase warranty and an open-list warranty is represented as:

$$i ( w ) = min \{ i \text{:} {min}_{j \leq i} \{ {jp}_{tr} + {V}_{w}^{tr} ( i , j ) \} = {min}_{k \leq i} \{ {kp}_{o} + {V}_{w}^{o} ( i , k ) \} \} .$$

Method 100 can include determining that for a number of products larger than î(w), a customer is expected to purchase the open-list warranty rather than the tied-at-purchase warranty.

Although not shown in FIG. 1, method 100 can include increasing an expected provider profit according to the expected customer decisions as a function of the unit price of the product, the unit price of the tied-at-purchase warranty, the unit price of the open-list warranty, and the maximum number of products supported by the open-list warranty. In an example, the expected provider profit function can be expressed as:

π(h,pₜᵣ,pₒ,nₒ,t)=Σ_{w}α(w)[γi*(w)+pₜᵣj*(w)−T(i*(w),j*(w),t)+pₒk*(w)−S(i*(w),k*(w)nₒ,t)]

where the size of the market (e.g., a number of customers) can be normalized to 1; α(w) can represent a fraction of customers that are type w; γ can represent a profit earned by the provider per unit of the product sold; T(i,j,t) can represent the expected provider product support cost for i products over t portions of the time period, given that the customer purchased j tied-at-purchase warranties, and S(i,knₒ,t) can represent the expected provider product support cost, as previously discussed, over t portions of the time period for i products, given that the customer purchased k open-list warranties, each of which supporting up to nₒ products. Pricing the open-list warranty can include fixing one or more of the unit price of the product, the time period, and/or the unit price of a tied-at-purchase warranty. Pricing the open-list warranty can include selecting value(s) for the unit price of the open-list warranty and/or the number of products supported by the open-list warranty to increase (e.g., maximize) a provider profit, as illustrated in the above function.

Examples of the present disclosure do not limit pricing the open-list warranty to fixing a number of values and varying other values to increase the profit function; rather pricing the open-list warranty can include varying (e.g., varying individually and/or in combination) the unit price of the product, the time period, the unit price of a tied-at-purchase warranty, the unit price of the open-list warranty and/or the number of products owned by the customer supported by the open-list warranty to increase the profit function. Varying these values can, for example, allow the provider to determine a price for the open-list warranty. For example, the provider can earn increased profits from customers that prefer purchasing smaller quantities of products by increasing the price of a tied-at-purchase warranty. The provider can, for example, increase purchases (e.g., profits) from customers that prefer purchasing larger quantities of products by offering them a number of open-list warranties at lower price(s).

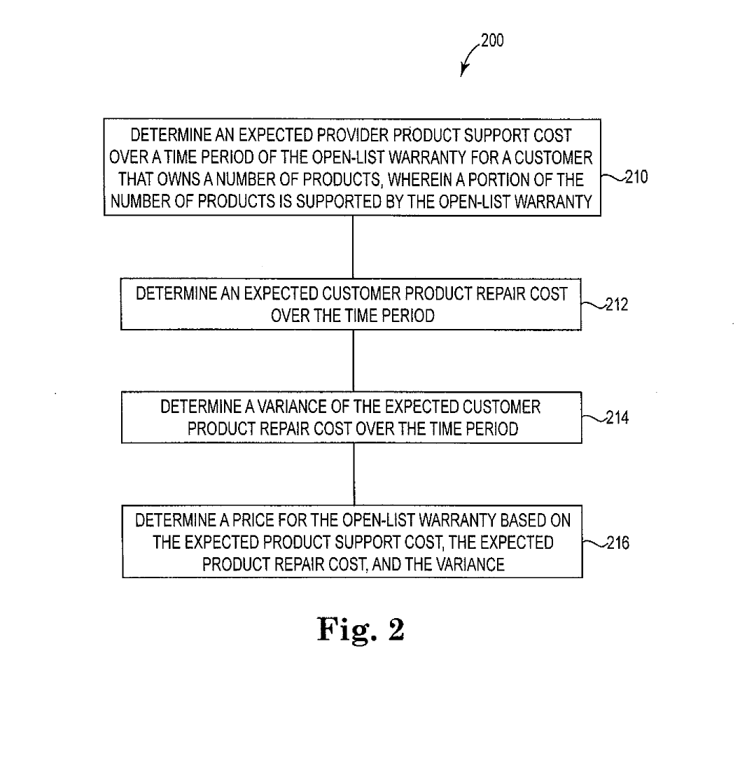

FIG. 2 is a flow chart illustrating an example of a method 200 for pricing an open-list warranty in accordance with one or more embodiments of the present disclosure. At block 210, an expected provider product support cost over a time period of the open-list warranty is determined for a customer that owns a number of products, wherein a portion of the number of products is supported by the open-list warranty. The expected provider product support cost can be determined in a manner analogous to that as previously discussed in connection with block 102 of FIG. 1.

At block 212, an expected customer product repair cost over the time period is determined. The expected customer product repair cost can be determined in a manner analogous to that as previously discussed in connection with block 104 of FIG. 1.

At block 214, a variance of the customer product repair cost over the time period is determined. The variance of the customer product repair cost can be determined in a manner analogous to that as previously discussed in connection with FIG. 1.

At block 216, a price for the open-list warranty is determined based on the expected product support cost, the expected product repair cost, and the variance. The price for the open-list warranty can be determined in a manner analogous to pricing the open-list warranty as previously discussed in connection with block 106 of FIG. 1. However, examples of the present disclosure do not limit factors used to determine a price of the open-list warranty; rather, the price can be determined based on additional factors, such as, for example, customer segments and/or geographic regions, among other factors.

FIG. 3 illustrates a block diagram 320 of a computing system including a computer-readable medium in communication with processing resources for pricing open-list warranties in accordance with one or more examples of the present disclosure. Computer-readable medium (CRM) 322 can be in communication with a computing device 324 (e.g., Java application server) having processor resources of more or fewer than 328-1, 328-2, . . . , 328-N, that can be in communication with, and/or receive a tangible non-transitory CRM 322 storing a set of computer-readable instructions 326 executable by one or more of the processor resources (e.g., 328-1, 328-2, . . . , 328-N) for pricing open-list warranties as described herein. The computing device may include memory resources 330, and the processor resources 328-1, 328-2, . . . , 328-N may be coupled to the memory resources 330.

Processor resources can execute computer-readable instructions 326 for pricing open-list warranties that are stored on an internal or external non-transitory CRM 322. A non-transitory CRM (e.g., CRM 322), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

Non-transitory CRM 322 can be integral, or communicatively coupled, to a computing device, in either in a wired or wireless manner. For example, non-transitory CRM 322 can be an internal memory, a portable memory, a portable disk, or a memory located internal to another computing resource (e.g., enabling the computer-readable instructions to be downloaded over the Internet).

CRM 322 can be in communication with the processor resources (e.g., 328-1, 328-2, . . . , 328-N) via a communication path 332. The communication path 332 can be local or remote to a machine associated with the processor resources 328-1, 328-2, . . . , 328-N. Examples of a local communication path 332 can include an electronic bus internal to a machine such as a computer where CRM 322 is one of volatile, non-volatile, fixed, and/or removable storage medium in communication with the processor resources (e.g., 328-1, 328-2, . . . , 328-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

Communication path 332 can be such that CRM 322 is remote from the processor resources (e.g., 328-1, 328-2, . . . , 328-N) such as in the example of a network connection between CRM 322 and the processor resources (e.g., 328-1, 328-2, . . . , 328-N). That is, communication path 332 can be a network connection. Examples of such a network connection can include a local area network (LAN), a wide area network (WAN), a personal area network (PAN), and the Internet, among others. In such examples, CRM 322 may be associated with a first computing device and the processor resources (e.g., 328-1, 328-2, . . . , 328-N) may be associated with a second computing device (e.g., a Java application server).

Processor resources 328-1, 328-2, . . . , 328-N coupled to the memory 330 can determine an expected provider product support cost over a time period of the open-list warranty for a customer that owns a number of products, wherein a first portion of the number of products is supported by the open-list warranty in a manner analogous to determining an expected product support cost as previously discussed in connection with FIG. 1. Processor resources 328-1, 328-2, . . . , 328-N can determine the expected product support cost recursively, conditioned on a number of products expected to fail during a particular portion of the time period in a manner analogous to that as previously discussed in connection with FIG. 1.

Further, processor resources 328-1, 328-2, . . . , 328-N can determine an expected customer cost over the time period to repair a second portion of the number of products not supported by the open-list warranty in a manner analogous to determining an expected product repair cost as previously discussed in connection with FIG. 1. Processor resources 328-1, 328-2, . . . , 328-N can determine the expected customer product repair cost recursively, conditioned on a number of products expected to fail during a particular portion of the time period in a manner analogous to that as previously discussed in connection with FIG. 1. Processor resources 328-1, 328-2, . . . , 328-N can determine a variance of the customer product repair cost over the time period in a manner analogous to that as previously discussed in connection with FIG. 1. Processor resources 328-1, 328-2, . . . , 328-N can, for example, determine a price for the open-list warranty based on the expected product support cost and the expected product repair cost, in a manner analogous to pricing the open list warranty as previously discussed in connection with FIG. 1. Processor resources 328-1, 328-2, . . . , 328-N can determine a price for the open-list warranty based on an expected profit earned by a provider for each product purchased by the customer from the provider, in a manner analogous to that as previously discussed in connection with FIG. 1.

Processor resources 328-1, 328-2, . . . , 328-N coupled to the memory 330 can determine a profit function for the provider as a function of the unit price of a product owned by the customer, a unit price of a tied-at-purchase warranty, a unit price of the open-list warranty, a number of products supported the open-list warranty, and/or the time period in a manner analogous to that as previously discussed in connection with FIG. 1. The processor resources 328-1, 328-2, . . . , 328-N coupled to the memory 330 can assign a value to a unit price of a product owned by the customer, a unit price of a tied-at-purchase warranty, a unit price of the open-list warranty, a number of products supported the open-list warranty, and/or the time period in a manner analogous to that as previously discussed in connection with FIG. 1.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

What is claimed:

1. A computer-implemented method for pricing an open-list warranty, comprising:
determining an expected product support cost of a provider of an open-list warranty to a customer over a time period;
determining an expected product repair cost of the customer over the time period; and
pricing the open-list warranty for the time period based on the expected product support cost and the expected product repair cost.

2. The method of claim 1, wherein the open-list warranty provides one of partial and full support for a computing device and a number of peripheral devices associated with the computing device.

3. The method of claim 1, wherein the customer owns a first number of products and the open-list warranty provides support for a maximum of a second number of products.

4. The method of claim 1, further comprising fragmenting the time period such that a product owned by the customer is expected to fail at most once during a fragment of the time period.

5. The method of claim 1, wherein the expected product repair cost is an average cost to repair a number of products not supported, at least in part, by the open-list warranty.

6. The method of claim 1, further comprising assigning a risk attitude to the customer.

7. The method of claim 1, wherein pricing the open-list warranty includes:
fixing at least one of a product price, the time period, and a unit price of a tied-at-purchase warranty; and
selecting a value for a unit price of the open-list warranty, a degree of support associated with the open-list warranty, and a number of products owned by the customer supported by the open-list warranty.

8. The method of claim 1, further comprising assigning values to a number of variables, the number of variables including:
a unit price of a product owned by the customer;
a unit price of a tied-at-purchase warranty;
a unit price of the open-list warranty;
a degree of support associated with the open-list warranty;
a number of products supported by the open-list warranty; and
the time period.

9. A non-transitory computer-readable medium storing a set of instructions for pricing an open-list warranty executable by a computer to cause the computer to:
determine an expected provider product support cost over a time period of the open-list warranty for a customer that owns a number of products, wherein a portion of the number of products is supported by the open-list warranty;
determine an expected customer product repair cost over the time period;
determine a variance of the customer product repair cost over the time period; and
determine a price for the open-list warranty based on the expected product support cost, the expected product repair cost, and the variance.

10. The non-transitory computer-readable medium of claim 9, wherein the instructions are executable by the computer to cause the computer to determine the expected product support cost based, at least in part, on:
a fixed component of the expected product support cost; and
a variable component of the expected product support cost, wherein the variable component of the expected product support cost is determined recursively, conditioned on a number of products expected to fail during a particular portion of the time period.

11. The non-transitory computer-readable medium of claim 9, wherein the instructions are executable by the computer to cause the computer to determine the expected customer product repair cost recursively, conditioned on a number of products expected to fail during a particular portion of the time period.

12. The non-transitory computer-readable medium of claim 9, wherein the provider assigns a value to:
a unit price of a product owned by the customer;
a unit price of a tied-at-purchase warranty;
a unit price of the open-list warranty;
a degree of support associated with the open-list warranty;
a number of products supported by the open-list warranty; and
the time period.

13. A system for pricing an open-list warranty, comprising:
a memory; and
a processor coupled to the memory, wherein the memory includes instructions executed by the processor to:
determine an expected provider product support cost over a time period of the open-list warranty for a customer that owns a number of products, wherein a first portion of the number of products is at least partially supported by the open-list warranty;
determine an expected customer product cost over the time period to repair a second portion of the number of products not supported by the open-list warranty;
determine a price for the open-list warranty based on the expected product support cost and the expected product repair cost.

14. The system of claim 13, wherein the processor coupled to the memory determines a price for the open-list warranty based on an expected profit earned by the provider for a number of products purchased by the customer from the provider.

15. The system of claim 13, wherein the processor coupled to the memory determines a profit function for the provider of the open-list warranty as a function of:
a unit price of a product owned by the customer;
a unit price of a tied-at-purchase warranty;
a unit price of the open-list warranty;
a degree of support associated with the open-list warranty;
a number of products supported by the unit price of the open-list warranty; and
the time period.
